(19) United States
(12) Patent Application Publication
(10) Pub. No.: US 2004/0079445 A1
(43) Pub. Date: Apr. 29, 2004

(54) High performance magnetic materials with low flux-aging loss

(76) Inventors: Zhongmin Chen, Apex, NC (US); Benjamin R. Smith, Raleigh, NC (US); Bao-Min Ma, Apex, NC (US)

Correspondence Address: JONES DAY, 51 Louisiana Aveue, N.W, WASHINGTON, DC, 20001-2113, US

(21) Appl. No.: 10/278,843

(22) Filed: Oct. 24, 2002

(51) Int. Cl. H01F 1/057

(52) U.S. Cl. 148/101; 148/302

(57) ABSTRACT

The present invention relates to magnetic materials made by rapid solidification processes which exhibit high remanence and intrinsic coercivity values and low flux-aging loss. More specifically, the invention relates to isotropic Nd—Fe—B type materials with remanence and intrinsic coercivity values of greater than 8.0 kG and 10.0 kOe, respectively, at room temperature, and bonded magnets made from the magnetic materials with low flux-aging loss and are suitable for high temperature applications. The invention also relates to methods of making the magnetic materials and the bonded magnets.

### FIELD OF THE INVENTION

The present invention relates to magnetic materials that are made by rapid solidification processes and exhibit high remanence and intrinsic coercivity values and low flux-aging loss. More specifically, the invention relates to isotropic Nd—Fe—B type materials with remanence and intrinsic coercivity values of greater than 8.0 kG and 10.0 kOe, respectively, at room temperature, and bonded magnets made from the magnetic materials with low flux-aging loss, which magnets are suitable for high temperature applications. The invention also relates to methods of making the magnetic materials and the bonded magnets.

### BACKGROUND OF THE INVENTION

Isotropic Nd₂Fe₁₄B-type melt-spun materials have been used for making bonded magnets for many years. Because of their low Curie temperature, i.e., the temperature above which a ferromagnetic material loses its permanent magnetism, and strong temperature dependence of the anisotropy field, however, the original stoichiometric Nd₂Fe₁₄B type materials were generally limited to operation temperatures of below 150° C. In the past two decades, many modifications have been made by various investigators in an attempt to improve the thermal stability of Nd₂Fe₁₄B-based materials and to enable them to be suitable for a higher operation temperature. Most of these modifications, however, have been unsuccessful.

When dealing with the thermal stability of melt-spun Nd₂Fe₁₄B materials, conventional wisdom generally is concerned with three factors: the Curie temperature (T_{c}), reversible temperature coefficient of remanence (Bᵣ), and the temperature coefficient of intrinsic coercivity (H_{ci}) (the two temperature coefficients are commonly known as α and β, respectively). A fourth factor, namely flux-aging loss, has often been omitted from many considerations, partly because of its complexity. Nevertheless, flux-aging loss is important to the long-term thermal stability of the magnet and to magnet circuit designs. Moreover, magnet end users also desire materials of high Bᵣ and H_{ci} values and low flux-aging loss, so that the magnet will perform well when exposed to their operation temperatures for a sustained period of time.

It is well known that cobalt (Co) substitution for iron (Fe) increases the T_{c} of Nd₂(Fe₁₋ₓCoₓ)₁₄B-based inter-metallic compounds and, consequently, improves the reversible temperature coefficient of Bᵣ, i.e., α. This approach has been widely adopted and considered to be essential by many investigators to improve the thermal stability of Nd₂Fe₁₄B-based materials. For example, U.S. Pat. No. 4,792,368 to Sagawa et al. discloses magnetic materials comprising Fe, B, R (rare earth) and Co, which are claimed to have a higher Curie temperature than corresponding Fe—B—R based materials containing no Co. However, cobalt, in addition to being an expensive material and often difficult to obtain, may adversely affect the flux-aging loss of the magnetic materials. Thus, magnetic materials requiring cobalt can be not only more expensive and undependable at in terms of availability, but also have potential undesirable affects on the properties of the materials.

Heavy rare earth elements, such as Dy, Tb and Ho, have also been used to substitute for Nd and have been known to increase the anisotropy field of Nd₂Fe₁₄B-type materials and, subsequently, increase the H_{ci} values of the materials at room temperature and reduce the temperature coefficient of H_{ci}, i.e., β. For example, U.S. Pat. No. 4,902,360 by Ma et al. discloses a permanent magnet alloy consisting essentially of R₂Fe₁₄B, wherein R is a combination of Nd and Ho and claims that the alloy has a low temperature coefficient. However, unlike Nd, the effective magnetic moment of heavy rare earth elements, such as Dy, Th and Ho, may couple with Fe in an anti-parallel fashion in the Nd₂Fe₁₄B system, decreasing the Bᵣ value significantly. This reduction in Bᵣ value is undesirable for many advanced applications demanding a high Bᵣ or (BH)ₘₐₓ value.

Many investigators have also reported the use of refractory metals, such as niobium (Nb), to improve the thermal stability of Nd₂Fe₁₄B type materials, e.g., through reducing and refining the grain size of the melt spun materials. Finer average grain sizes usually lead to an increase in H_{ci} value and improvement in the squareness of the second quadrant demagnetization curve. For example, U.S. Pat. No. 5,022,939 by Yajima et al. discloses a permanent magnet material having high coercivity and energy product which contains rare earth elements, B, Fe and Co, and M, wherein M is at least one element of Ti, V, Cr, Zr, Nb, Mo, Hf, Ta and W. The patent claims that the addition of the M element controls the grain growth and maintains the coercive force through high temperatures for a long time. Refractory metal additions, however, often form refractory metal-borides and may decrease the Bᵣ value of the magnetic materials obtained, unless average grain size and refractory metal-borides can be carefully controlled and uniformly dispersed throughout the materials to enable exchange coupling to occur.

Many improvements of melt spinning technology have also been documented to control the microstructure of the Nd₂Fe₁₄B type materials in an attempt to obtain materials of higher magnetic performance. However, these documents only deal with broad and general processing improvements without discussing specific materials and/or applications.

Therefore, there is still a need for Nd₂Fe₁₄B-based materials that, while exhibiting high values of Bᵣ and/or H_{ci}, have improved thermal stability, e.g., lower α, β, and/or lower flux-aging loss at elevated temperatures for a sustained period of time.

### SUMMARY OF THE INVENTION

The present invention encompasses novel Nd—Fe—B type magnetic materials and bonded magnets with improved thermal stability, e.g., lower α, β, and/or low flux-aging loss, while exhibiting high values of Bᵣ and H_{ci}.

In one aspect, this invention provides a magnetic material having the composition, in atomic percentage, of REₓFe_{100-x-y-z}M_{y}B_{z}, wherein RE is one or more of Y La, Ce, Pr, Nd, Sm, Er, Gd, Tb, Dy, Ho, Tm, Yb and Lu; M is one or more of Nb, Ti, Cr, Mo, W, and Hf, x is from about 11.0 to about 12.5, y is from about 0.5 to about 3, and z is from about 4.5 to about 7.0. The magnetic material is prepared by a rapid solidification process, which is followed by a thermal annealing process at a temperature range of about 350° C. to about 700° C. for about 2 to about 120 minutes. Further, the magnetic material exhibits a remanence (Bᵣ) value of greater than about 8.0 kG and an intrinsic coercivity (H_{ci}) value of greater than about 10.0 kOe. In one embodiment, the rapid solidification process is a melt-spinning or jet casting process.

In a specific embodiment of the magnetic material, RE is Nd and M is Nb, Ti, or Cr. More specifically, M is Nb or Ti. In another specific embodiment of the magnetic material, x, y and z are independent from each and are from about 11.1 to about 12.0, from about 1.0 to about 2.0 and from about 5.0 to about 6.0, respectively. More specifically, x is from 11.2 to about 11.9, y is from about 1.2 to about 1.8 and z is from about 5.3 to about 6.5. In one specific embodiment, x is from about 11.4 to about 11.7, y is from about 1.3 to about 1.7 and z is from 5.7 to 6.0.

In another specific embodiment, the magnetic material is prepared by a thermal annealing process at a temperature range of about 600° C. to about 700° C. for about 2 to about 10 minutes.

In another specific embodiment, the magnetic material of the invention exhibits a Bᵣ value of greater than about 8.3 kG and, independently, an H_{ci} value of greater than about 11.5 kOe, or greater than about 12.0 kOe. In another embodiment, the magnetic material of the invention exhibits a near stoichiometric Nd₂Fe₁₄B single-phase microstructure, as determined by X-Ray diffraction. The magnetic material may have crystal grain sizes ranging from about 1 nm to about 50 nm, or from about 5 nm to about 20 nm.

In another aspect, the present invention provides a bonded magnet that comprises a bonding agent and a magnetic material having the composition, in atomic percentage, of NdₓFe_{100-x-y-z}M_{y}B_{z}, wherein M is one or more of Nb, Ti, Cr, Mo, W, and Hf, x is from about 11.0 to about 12.5, y is from about 0.5 to about 3, and z is from about 4.5 to about 7.0. The magnetic material is prepared by a rapid solidification process followed by a thermal annealing process at a temperature range of about 350° C. to about 700° C. for 2 to 120 minutes and exhibits a remanence (Bᵣ) value of greater than about 8.0 kG and an intrinsic coercivity (H_{ci}) value of greater than about 10.0 kOe. In one embodiment, the rapid solidification process is a melt-spinning or jet-casting process.

In a specific embodiment, the bonded magnet comprises a bonding agent which is epoxy, polyamide, polyphenylene sulfide, a liquid crystalline polymer, or a combination thereof. More specifically, the bonding agent is epoxy. In another embodiment, the bonding agent further comprises one or more additives selected from a high molecular weight multi-functional fatty acid ester, stearic acid, hydroxy stearic acid, a high molecular weight comples ester, a long chain ester of pentaerythritol, palmitic acid, a polyethylene based lubricant concentrate, an ester of montanic acid, a partly saponified ester of montanic acid, a polyolefin wax, a fatty bis-amide, a fatty acid secondary amide, polyoctanomer with high trans content, maleic anhydride, glycidyl-functional acrylic hardener, zinc stearate, and polymeric plasticizer. More specifically, the additive is zinc stearate.

In another specific embodiment, the bonded magnet of the present invention comprises, by weight, from about 1% to about 5% epoxy and from about 0.01% to about 0.05% zinc stearate. More specifically, the magnet comprises, by weight, about 2% epoxy and about 0.02% zinc stearate.

The bonded magnet of the present invention may be made by compression molding, injection molding, calendering, extrusion, screen printing, or combinations thereof. The bonded magnet, in a specific embodiment, has a permeance coefficient of from about 0.2 to about 12.0, and more specifically, about 2.0.

In a specific embodiment, the bonded magnet of the invention exhibits a flux-aging loss of less than about 7.0% when aged at about 180° C. for about 100 hours. More specifically, the magnet exhibits a flux-aging loss of less than about 6.0% or less than 5.5%.

The present invention further provides a method of making a magnetic material. The method comprises forming a melt comprising the composition, in atomic percentage, of REₓFe_{100-x-y-z}M_{y}B_{z}; rapidly solidifying the melt to obtain a magnetic powder; and thermally annealing the magnetic powder at a temperature range of about 350° C. to about 700° C. for about 2 to about 120 minutes. As to the composition in the method, RE is one or more of Y, La, Ce, Pr, Nd, Sm, Er, Gd, Tb, Dy, Ho, Tm, Yb and Lu; M is one or more of Nb, Ti, Cr, Mo, W, and Hf; x is from about 11.0 to about 12.5; y is from about 0.5 to about 3; and z is from about 4.5 to about 7.0. Also, the magnetic material made by the method exhibits a remanence (Bᵣ) value of greater than about 8.0 kG and an intrinsic coercivity (H_{ci}) value of greater than about 10.0 kOe.

The present invention additionally provides a method of making a bonded magnet. The method comprises forming a melt comprising the composition, in atomic percentage, of REₓFe_{100-x-y-z}M_{y}B_{z}; rapidly solidifying the melt to obtain a magnetic powder; and thermally annealing the magnetic powder at a temperature range of about 350° C. to about 700° C. for about 2 to about 120 minutes; mixing and/or coating the magnetic powder with a binding agent; and pressing and/or molding the powders and binding agent;. As to the composition in the method, RE is one or more of Y, La, Ce, Pr, Nd, Sm, Er, Gd, Tb, Dy, Ho, Tm, Yb and Lu; M is one or more of Nb, Ti, Cr, Mo, W, and Hf; x is from about 11.0 to about 12.5; y is from about 0.5 to about 3; and z is from about 4.5 to about 7.0. Also, the magnetic material exhibits a remanence (Bᵣ) value of greater than about 8.0 kG and an intrinsic coercivity (H_{ci}) value of greater than about 10.0 kOe.

### BRIEF DESCRIPTION OF THE FIGURES

FIG. 1 illustrates the limitations of conventional technology and the approach of the present invention in improving magnetic properties of Nd—Fe—B based materials.

FIG. 2 illustrates specific composition ranges of this invention's materials on a ternary phase diagram.

FIG. 3 illustrates an X-Ray diffraction pattern of a magnetic powder of this invention's materials.

FIG. 4 illustrates a Transmission Electron Microscopy micrograph of a material of this invention.

FIGS. 5A & 5B illustrate second quadrant demagnetization curves of this invention's materials as compared to that of a control materials.

FIG. 6 illustrates flux-aging losses of this invention's magnet, as compared to that of conventional magnet.

FIGS. 7A & 7B illustrate a comparison of Transmission Electron Microscopy micrographs of a material of this invention and that of a control material.

### DETAILED DESCRIPTION OF THE INVENTION

This invention provides, in part, a thermally stable Nd—Fe—B type material made by rapid solidification, for applications at elevated temperatures, e.g., at above 150° C. and/or at or above 180° C. More specifically, the invention encompasses novel Nd—Fe—B type materials, and bonded magnets made from the materials, with improved temperature coefficients α and β and/or flux-aging loss, while exhibiting high values of Bᵣ and H_{ci}.

As discussed herein, conventional attempts to improve the properties of Nd—Fe—B type materials have been directed to increasing either: (i) the Bᵣ value, e.g., by substituting a portion of Fe with Co, or (ii) the H_{ci} value, e.g., by composition adjustment or alloy element additions. These attempts, however, have not only been limited in their success, but have often ignored the importance of reducing the material's flux-aging loss, which may hold the key for improving the properties of Nd—Fe—B type materials.

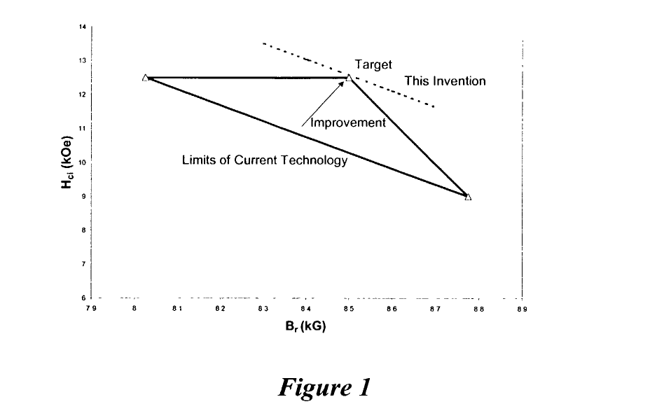

As illustrated in FIG. 1, current technology is often limited by a “trade-off” between the value of Bᵣ and the value of H_{ci}, i.e., an increase in the Bᵣ value is often at the expense of the H_{ci} value, and vice versa (see solid line). The present invention, on the other hand, provides materials that have improved values for both Bᵣ and H_{ci}, or improved value for one while maintaining the value for the other (see dotted line). One of the invention's efforts is focused on the microstructure refinement through alloy design and process control. The proposed target for room-temperature magnetic properties and its relationship to those of typical current materials is also sketched in FIG. 1 (see Target). As can be seen, in addition to the improved thermal stability, it is also intention of the invention to obtain powder of higher Bᵣ while maintaining the H_{ci} at the same level.

Therefore, in one aspect, the invention provides a magnetic material that has a composition, in atomic percentage, of REₓFe_{100-x-y-z}M_{y}B_{z}, wherein RE is one or more of rare earth elements such as Y, La, Ce, Pr, Nd, Sm, Er, Gd, Tb, Dy, Ho, Tm, Yb and Lu; M is one or more of Nb, Ti, Cr, Mo, W, and Hf; and x is from about 11.0 to about 12.5, y is from about 0.5 to about 3, and z is from about 4.5 to about 7.0. The magnetic material is prepared by a melt-spinning or jet casting process, which is followed by a thermal annealing process at a temperature range of about 350° C. to 700° C. for about 2 to 120 minutes. Further, the magnetic material exhibits a remanence (Bᵣ) value of greater than about 8.0 kG and an intrinsic coercivity (H_{ci}) value of greater than about 10.0 kOe.

In one embodiment, RE is one or more of light rare earth elements such as lanthanum (La), cerium (Ce), praseodymium, (Pr), neodymium (Nd), promethium (Pm), samarium (Sm), europium (Eu), and gadolinium (Gd). In a more specific embodiment, RE is Nd. In another embodiment, the magnetic material of this invention does not contain, except for unavoidable impurities, any heavy rare earth element such as terbium (Tb), dysprosium (Dy), holmium (Ho), erbium (Er), thulium (Tm), ytterbium (Yb) and lutetium (Lu). In yet another embodiment, the magnetic material of this invention contains no cobalt (Co), except as unavoidable impurities in certain situations.

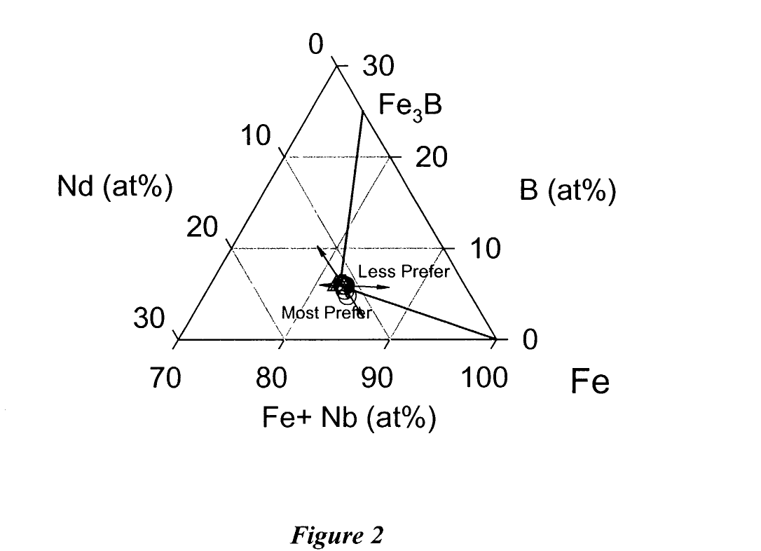

In one embodiment, the rare earth element is Nd and the magnetic material has a composition that exhibits near stoichiometric Nd₂Fe₁₄B structure. FIG. 2 illustrates a ternary phase diagram showing specific compositional ranges of this invention. As illustrated, preferred compositions of the present invention are near the point of stoichiometric composition of Nd₂Fe₁₄B (approximately 11.76 at % Nd, 82.35 at % of Fe and 5.88 at % of B), which is also the Nd₂Fe₁₄B-vertex of the triangle bounded by the Fe—, Fe₃B—, and the Nd₂Fe₁₄B-vertexes. Furthermore, as discovered in the present invention, when near the Nd₂Fe₁₄B-vertex, compositions lying outside the phase field bounded by the Nd₂Fe₁₄B—Fe—Fe₃B triangle (see, arrows marked as “more preferred”) yields lower flux-aging losses than those lying within the triangle (see, arrows marked as “less preferred”).

Thus, in a specific embodiment of the magnetic material, x, y and z, which are independent from each other, have values that make the composition of the material of the present invention to be near the stoichiometric composition of Nd₂Fe₁₄B. For example, x preferably ranges from 11.1 to 12.0, more preferably from 11.2 to 11.9, and most preferably from 11.4 to 11.7. Y preferably ranges from 1.0 to 2.0, more preferably from 1.2 to 1.8, and most preferably from 1.3 to 1.7. Z preferably ranges from 5.0 to 6.0, more preferably from 5.3 to 6.5, and most preferably from 5.7 to 6.0.

According to the present invention, the addition of an M element, in small and specific amounts, may help improve Bᵣ and/or H_{ci} values and reduce flux-aging loss. In a specific embodiment, M is a refractory metal such as Nb, Ti, Cr, Mo, W, and Hf. In a preferred embodiment, M is Nb, Ti, or Cr. More preferably, M is Nb or Ti. The most preferred M is Nb. The presence of the M element is controlled, as discussed herein, by both amount and process of integration such that the magnetic material exhibits a near single-phase microstructure, as determined by X-Ray diffraction.

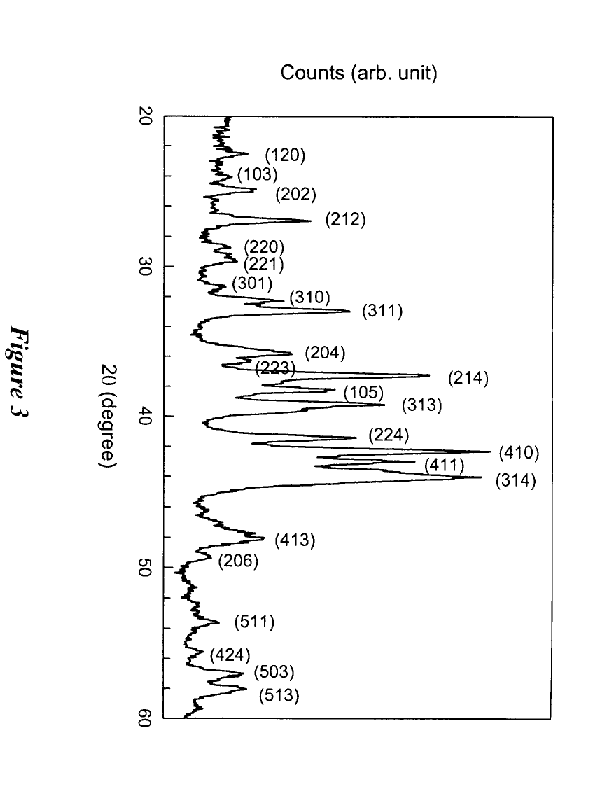

As demonstrated in FIG. 3, the magnetic materials of the present invention, in another embodiment, exhibits a near stoichiometric Nd₂Fe₁₄B single-phase microstructure, as determined by X-Ray diffraction. As illustrated in FIG. 3, the X-Ray Powder Diffraction (“XRD”) of a powder of this invention exhibits only the characteristic peaks of Nd₂Fe₁₄B, as demonstrated by the indexed peaks. Thus, the present invention provides a magnetic material which, while exhibiting the single-phase microstructure of a stoichiometric Nd₂Fe₁₄B material, possesses improved characteristics due to the addition of a refractory metal, such as Nb, which is added to the material through quantity and process control, as discussed herein.

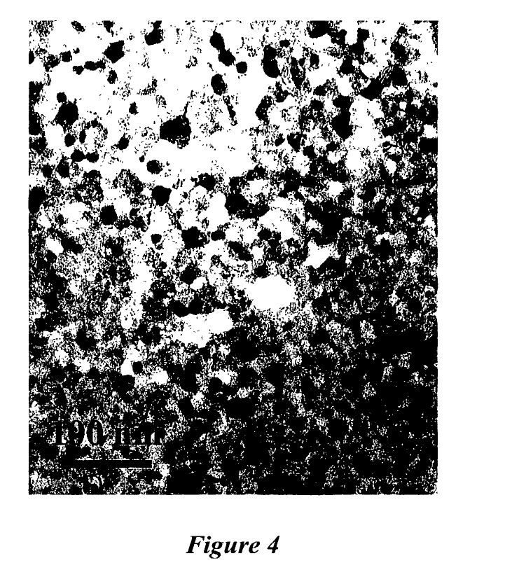

In another embodiment, the magnetic material of the present invention exhibits small and uniform crystal grain sizes. FIG. 4 shows a Transmission Electron Microscopy (“TEM”) of a material of this invention, wherein relatively uniform and fine grain sizes, averaging approximately 15-30 nm, can be observed. This embodiment of the magnetic materials of the present invention has no detectable secondary phases based on the TEM micrograph shown in FIG. 4, secondary phases were not detected. Thus, in a specific embodiment of the present invention, the magnetic material has crystal grain sizes ranging from about 1 nm to about 50 nm, more specifically, from about 5 nm to about 20 nm. In one embodiment, the magnetic material has an average crystal grain size of about 15 nm.

Magnetic materials of the present invention can be made from molten alloys of the desired composition which are rapidly solidified into powders/flakes by a melt-spinning or jet-casting process. In a melt-spinning or jet-casting process, a molten alloy mixture is flowed onto the surface of a rapidly spinning wheel. Upon contacting the wheel surface, the molten alloy mixture forms ribbons, which solidify into flake or platelet particles. The flakes obtained through melt-spinning are relatively brittle and have a very fine crystalline microstructure. The flakes can also be further crushed or comminuted before being used to produce magnets. The cooling rate during the melt-spinning process can be controlled by both the mass flow rate and the wheel spinning speed. The magnetic materials of the present invention can also be made by an atomization process, such an inert gas atomization or a centrifugal atomization process, as described in U.S. patent application Ser. No. 09/794,018, filed Feb. 28, 2001, the contents of which is incorporated herein by reference.

According to the present invention, magnetic materials, usually powders, obtained by the melt-spinning or jet-casting process are heat treated to improve their magnetic properties. Any commonly employed heat treatment method can be used, although the heat treating step preferably comprises annealing the powders at a temperature between 350° C. to 700° C., or preferably between 600° C. to 700° C., for 2 to 120 minutes to obtain the desired magnetic properties. In a specific embodiment, the annealing process lasts for from about 2 to about 10 minutes.

Two of the properties important to permanent magnet applications are the squareness of the second quadrant demagnetization curve of intrinsic magnetization, or the 4 πM curve, of the magnet and the straightness of the second quadrant induction curve, or the B curve. The squareness of the 4 πM curve is defined as the ration of Hₖ to H_{ci}, i.e.,

Squareness=Hₖ/H_{ci}

where Hₖ is the demagnetizing field at 90% of Bᵣ. Although there is unique model describing the theoretical limits for magnets of randomly oriented grains with uniaxial anisotropy, a squareness of greater than 0.5 is considered to be excellent by empirical computer simulations, as demonstrated by S. Chikazumi, Physics of Ferromagnetism, 2^{nd} Ed., page 2 (FIG. 18.38) (Oxford Science Publication, Oxford, UK).

Similarly, the straightness of the B curve is defined as the ratio of the product of Bᵣ and H_{c} to 4 multiply (BH)ₘₐₓ, i.e.,

Straightness=(Bᵣ×H_{c})/(4×BHₘₐₓ)

For the ideal case, where there is a perfect square demagnetization curve or a straight B curve, the squareness should be unity. When the straightness is less than one, it means the B curve bend inward to the origin and the magnet can not recover to its original magnetization state if exposed to a demagnetizating magnetic field. This also means that the magnet will encounter significant flux loss, for a demagnetizing field. This also means that the magnet will encounter significant flux loss, for a given load line, when exposed to elevated temperatures.

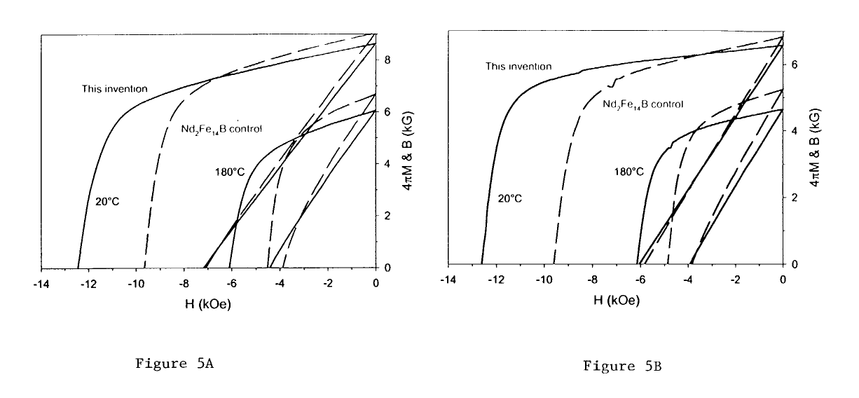

FIG. 5A shows a comparison of the second quadrant demagnetization curves, the 4 πM curves and B curves, of magnetic powders of the present invention (solid lines) and the stoichiometric Nd₂Fe₁₄B control (dotted lines) at 20° C. and 180° C. FIG. 5B shows a similar comparison between the epoxy bonded magnets of the present invention (solid lines) and the control (dotted lines). As shown, the 4 πM curves are relatively square and B curves straight for the present invention's magnetic powder and magnet, indicating, among other things, good thermal stability for the temperatures tested. As to the control (Nd₂Fe₁₄B), however, the 4 πM curves are not as square and the B curves not as straight, especially at 180° C., indicating thermal unstability.

The magnetic properties underlining the 4 πM curves and the B curves in FIGS. 5A & 5B are shown in Table 1.

TABLE 1

| | Bᵣ | H_{ci} | H_{c} | Hₖ | (BH)ₘₐₓ | Square- | Straight- |
|---|---|---|---|---|---|---|---|
| Samples | kG | kOe | kOe | kOe | MGOe | ness | ness |
| Ideal Case | | | | | | | 1.00 |

Powders

| | | | | | |
|---|---|---|---|---|---|
| This | 8.62 | 12.44 | 7.16 | 15.62 | 0.99 |
| invention | | | | | |
| at 20° C. | | | | | |
| This | 6.04 | 6.08 | 4.41 | 7.04 | 0.94 |
| invention | | | | | |
| at 180° C. | | | | | |
| Control | 9.04 | 9.65 | 7.07 | 16.64 | 0.96 |
| at 20° C. | | | | | |
| Control | 6.67 | 4.51 | 3.86 | 7.81 | 0.82 |
| at 180° C. | | | | | |

Magnets

| | | | | | | | |
|---|---|---|---|---|---|---|---|
| This | 6.56 | 12.41 | 6.06 | 7.38 | 9.73 | 0.58 | 1.00 |
| invention | | | | | | | |
| at 20° C. | | | | | | | |
| This | 4.64 | 6.14 | 3.92 | 2.93 | 4.67 | 0.48 | 0.97 |
| invention | | | | | | | |
| at 180° C. | | | | | | | |
| Control | 6.83 | 9.60 | 5.83 | 4.18 | 10.05 | 0.44 | 0.99 |
| at 20° C. | | | | | | | |
| Control | 5.24 | 4.87 | 3.83 | 2.14 | 5.51 | 0.44 | 0.91 |
| at 180° C. | | | | | | | |

As cab be seen, the squareness of the magnet of this invention are 0.58 and 0.48 at 20° C. and 180° C., respectively, which are significantly higher than those of the control magnet (0.44 at both temperatures). As to the B curves, the straightness for the powder of this invention are 0.99 and 0.94 at 20° C. and 180° C., respectively, significantly higher than those for the control (0.96 and 0.82, respectively). Similarly, the straightness for the magnet of this invention, at 20° C. and 180° C., are 1.00 and 0.97, respectively, significantly higher than those of the control (0.99 and 0.91, respectively).

According to the present invention, high values of both Bᵣ and H_{ci} can be achieved and/or maintained for the magnetic material, in addition to a reduction of flux-aging loss, through composition and process control, as discussed herein. In a specific embodiment, the magnetic material of the invention exhibits a Bᵣ value of greater than about 8.0 kG. More specifically, the Bᵣ value of the material is greater than about 8.3 kG or 8.5 kG. At the same time, the material's H_{ci} value, which is independent from the Bᵣ value, can be greater than about 10.0 kOe, 11.5 kOe, or 12.0 kOe.

A specific characteristic of the present invention's magnetic material is illustrated in FIGS. 5A & 5B. As can be seen in FIG. 5A, magnetic powder of this invention (represented by the solid line) exhibits a slightly lower Bᵣ (approximately 8.6 kG) at 20° C. when compared to that of the control sample (approximately 9.0 kG, see dotted line). A similar result in Bᵣ value can also be seen at 180° C. (Bᵣ of approximately 6.0 kG for the present invention and 6.7 kG for that of the control). However, significant differences can be observed when one compares the H_{ci} values of the present invention's magnetic powder and that of the control. As shown in FIG. 5A, at 20° C., the H_{ci} value of the invention's powder is approximately 12.4 kOe, as compared to approximately 9.8 kOe for that of the control; and at 180° C., the H_{ci} value of the invention's powder is approximately 6.1 kOe, as compared to approximately 4.5 kOe for that of the control. Not to be restricted to any particular theory, this significant increase in the values of H_{ci} may be ascribed to the unique combination of chemical composition and process control for the microstructure provided by the present invention.

FIG. 5B illustrates similar comparison results between the bonded magnet (containing about 2 wt % epoxy) of the present invention and a control magnet. As shown, even though the Bᵣ, at both 20 & 180° C., of the invention's bonded magnet is slightly less than that of the control (approximately 6.6 kG versus 6.8 kG and Approximately 4.7 kG versus 5.2 kG, respectively), the H_{ci} value, at both 20 & 180° C., of the invention's magnet is higher than that of the control magnet (approximately 12.5 versus 9.7 kOe and approximately 6.1 kOe versus 4.6 kOe, respectively). It should also be noted that the magnet of this invention exhibits nearly straight and square B—H demagnetization curves without any “knee,” which is a point at which the demagnetization curve ceases to be linear. As one or ordinary skill in the art understands, if the operating point of a magnet falls below the knee, the magnet will not be able to recover its original flux output without remagnetization. Thus, a property of the present invention's magnetic material and bonded magnet is that the material or magnet can operate at a wider range of temperature without irreversible loss of magnetism, a property that may be critical to certain applications.

The present invention further provides a method of making a magnetic material. The method comprises forming a melt comprising the composition, in atomic percentage, of REₓFe_{100-x-y-z}M_{y}B_{z}; rapidly solidifying the melt to obtain a magnetic powder; and thermally annealing the magnetic powder at a temperature range of about 350° C. to about 700° C. for about 2 to about 120 minutes. Specifically in the composition, RE is one or more of Y, La, Ce, Pr, Nd, Sm, Er, Gd, Tb, Dy, Ho, Tm, Yb and Lu; M is one or more of Nb, Ti, Cr, Mo, W, and Hf; x is from about 11.0 to about 12.5; y is from about 0.5 to about 3; and z is from about 4.5 to about 7.0. Also, the magnetic material made by the method exhibits a remanence (Bᵣ) value of greater than about 8.0 kG and an intrinsic coercivity (H_{ci}) value of greater than about 10.0 kOe. The various embodiments disclosed and/or discussed herein, such as the compositions of the magnetic material, rapid solidification processes, thermal annealing processes, and magnetic properties of the material, are encompassed by the method.

In another aspect, the present invention provides a bonded magnet that comprises a bonding agent and a magnetic material having a composition, in atomic percentage, of REₓFe_{100-x-y-z}M_{y}B_{z}, wherein RE is one or more of Y, La, Ce, Pr, Nd, Sm, Er, Gd, Tb, Dy, Ho, Tm, Yb and Lu; M is one or more of Nb, Ti, Cr, Mo, W, and Hf, and x is from about 11.0 to about 12.5, y is from about 0.5 to about 3, and z is from about 4.5 to about 7.0. The magnetic material is prepared by a melt-spinning or jet-casting process followed by a thermal annealing process at a temperature range of 350° C. to 700° C. for 2 to 120 minutes. Further, the magnet exhibits a remanence (Bᵣ) value of greater than about 8.0 kG and an intrinsic coercivity (H_{ci}) value of greater than about 10.0 kOe.

In a specific embodiment, the bonded magnet comprises a bonding agent which is epoxy, polyamide, polyphenylene sulfide, a liquid crystalline polymer, or a combination thereof. More specifically, the bonding agent is epoxy. In another embodiment, the bonding agent further comprises one or more additives selected from a high molecular weight multi-functional fatty acid ester, stearic acid, hydroxy stearic acid, a high molecular weight comples ester, a long chain ester of pentaerythritol, palmitic acid, a polyethylene based lubricant concentrate, an ester of montanic acid, a partly saponified ester of montanic acid, a polyolefin wax, a fatty bis-amide, a fatty acid secondary amide, a polyoctanomer with high trans content, a maleic anhydride, a glycidyl-functional acrylic hardener, zinc stearate, and a polymeric plasticizer. More specifically, the additive is zinc stearate.

In another specific embodiment, the bonded magnet of the present invention comprises, by weight, from about 1% to about 5% epoxy and from about 0.01% to about 0.05% zinc stearate. More specifically, the magnet comprises, by weight, about 2% epoxy and about 0.02% zinc stearate.

The bonded magnet of the present invention can be produced through a variety of pressing/molding processes, including, but not limited to, compression molding, extrusion, injection molding, calendering, screen printing, spin casting, and slurry coating. In a specific embodiment, the bonded magnet of the present invention is made, after the magnetic powders have been heat treated and mixed with the binding agent, by compression molding.

In another embodiment, the epoxy bonded magnet has a specific density of from about 4 to about 8 gm/cm³, or from about 4 to about 7.5 gm/cm³. More specifically, the epoxy bonded magnet has a specific density of about 6.0 gm/cm³. In another specific embodiment, the bonded magnet of the present invention has a permeance coefficient (“PC”) of from about 0.2 to about 12.0, and more specifically about 2.0.

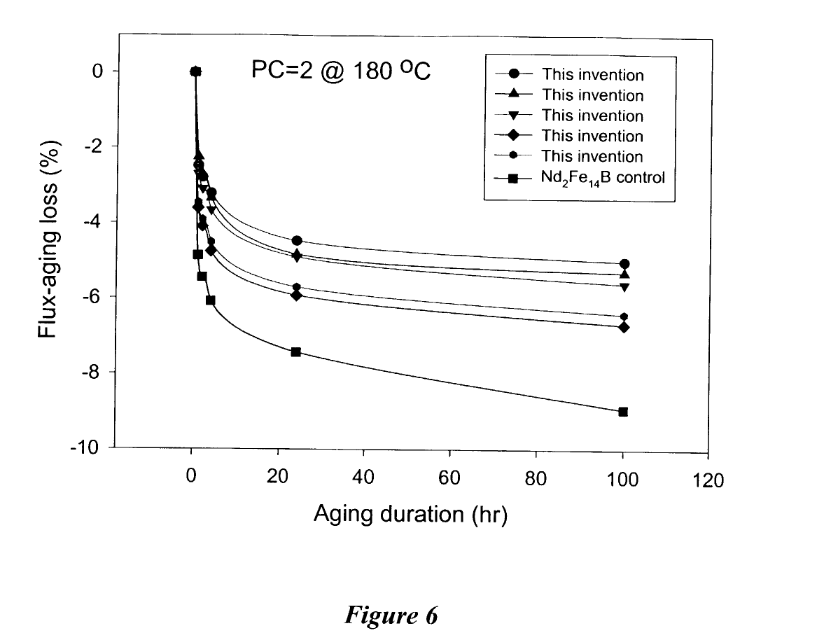

A unique characteristic of the present invention's bonded magnet is that it exhibits reduced flux-aging loss. As used in the present invention, “flux-aging loss” means the loss of magnetic flux of a magnet after being exposed at a specific temperature and for a specific period of time. In a specific embodiment, the bonded magnet of the invention exhibits a flux-aging loss of less than about 7.0% when aged at 180° C. for 100 hours. More specifically, the magnet exhibits a flux-aging loss of less than about 6.0% or less than about 5.5%, when aged at 180° C. for 100 hours. FIG. 6 illustrates a comparison of flux-aging losses of various embodiments of the epoxy bonded magnet of this invention anf that of the control (represented by the square symboled line). Both magnets comprise approximately 2 wt % epoxy and a PC of 2. As can bee seen, magnets made from powders of this invention exhibit lower flux-aging losses (from approximately −5% to −7%), as compared to that of controls (approximately −9.0%).

The present invention additionally provides a method of making a bonded magnet. The method comprises forming a melt comprising the composition, in atomic percentage, of REₓFe_{100-x-y-zmyBz}; rapidly solidifying the melt to obtain a magnetic powder; and thermally annealing the magnetic powder at a temperature range of about 350° C. to about 700° C. for about 2 to about 120 minutes; mixing and/or coating the magnetic powder with a binding agent; and pressing and/or molding the powders and binding agent. Specifically in the composition, RE is one or more of Y, La, Ce, Pr, Nd, Sm, Er, Gd, Tb, Dy, Ho, Tm, Yb and Lu; M is one or more of Nb, Ti, Cr, Mo, W, and Hf; x is from about 11.0 to about 12.5; y is from about 0.5 to about 3; and z is from about 4.5 to about 7.0. Also, the magnetic material exhibits a remanence (Bᵣ) value of greater than about 8.0 kG and an intrinsic coercivity (H_{ci}) value of greater than about 10.0 kOe. The various embodiments disclosed and/or discussed herein, such as the compositions of the magnetic material, rapid solidification processes, thermal annealing processes, compression processes, and magnetic properties of the magnetic material and the bonded magnet, are encompassed by the method.

### EXAMPLES

### Example 1

Alloy ingots having compositions, in atomic percentage, of Nd_{13 1}Fe_{81 4}B_{5 5}, Nd_{11 9}Fe_{77.2}Co_{5.5}B_{5.4}, Nd_{13.2}Fe_{64 0}Co_{17.2}B_{5 6}, Nd_{12 5}Fe_{65.0}Co_{16 9}B_{5.6}, Nd_{12.2}Fe_{79.7}Nb_{1.6}B_{6.5}, Nd_{11 5}Fe_{81 2}Nb_{1 4}B_{5 9} and Nd_{11 5}Fe_{81.4}Nb_{1.2}B_{5.9} were prepared by arc melting. A laboratory jet caster with a metallic wheel of good thermal conductivity was used for melt-spinning. A wheel speed of 10 to 30 meter/second (m/s) is used for preparing the samples. Melt-spun ribbons were crushed to less than 40 mesh and annealed at a temperature in the range of 600 to 700° C. for four about minutes to develop high values of Bᵣ and H_{ci}. This powder was then mixed with a 2 wt % of epoxy and 0.02 wt % of zinc stearate and dry-blended for about 30 minutes. The mixed compound was then compression-molded in air with a compression pressure of about 4 T/cm² to form magnets with diameters of about 9.2 mm and with a permeance coefficient of 2 (PC=2). Table 1 lists the nominal alloy compositions and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀).

TABLE I

| | Br | H_{ci} | (BH)ₘₐₓ | T_{c} | α %/ | β %/ | δ₁₈₀ | |
|---|---|---|---|---|---|---|---|---|
| Formula Expression | kG | kOe | MGOe | ° C. | ° C. | ° C. | % | Remarks |
| Nd_{13.1}Fe_{81.4}B_{5.5} | 8.20 | 14.21 | 13.80 | 307 | −0.187 | −0.362 | −7.6 | Control |
| Nd_{11.9}Fe_{77.2}Co_{5.5}B_{5.4} | 9.10 | 9.74 | 16.30 | 360 | −0.169 | −0.345 | −11.2 | Control |
| Nd_{13.2}Fe_{64.0}Co_{17.2}B_{5.8} | 8.00 | 17.62 | 13.25 | 469 | −0.139 | −0.369 | −8.9 | Control |
| Nd_{12.5}Fe_{65.0}Co_{16.9}B_{5.6} | 8.60 | 9.68 | 15.11 | 470 | −0.133 | −0.369 | −14.2 | Control |
| Nd_{12·2}Fe_{79.7}Nb_{1.6}B_{6.5} | 8.05 | 12.87 | 13.31 | 300 | −0.182 | −0.349 | −5.7 | This invention |
| Nd_{11·5}Fe_{81.2}Nb_{1.4}B_{5.9} | 8.53 | 12.40 | 15.20 | 300 | −0.187 | −0.318 | −5.01 | This invention |
| Nd_{11.5}Fe_{81.4}Nb_{1.2}B_{5.9} | 8.56 | 12.40 | 15.50 | 300 | −0.182 | −0.318 | −5.76 | This invention |

As can be seen, the Bᵣ and H_{ci} values of the control samples vary from 8.0 to 9.1 kG and 9.68 to 17.62 kOe, respectively. The T_{c} values of control samples range from 307 to 470° C. The δ₁₈₀ values range from −7.6 to −14.2%. It needs to be noted that the T_{c} of the control sample Nd_{12.5}Fe_{65.0}Co_{16.9}B_{5.6} is as high as 470° C. and the δ₁₈₀ as high as −14.2%. Thus, a high T_{c} does not translate into an advantage in improving δ₁₈₀. Similarly, the control sample Nd_{13 1}Fe_{81 4}B_{5 5} exhibits a H_{ci} of 14.21 kOe and a δ₁₈₀ of −7.6%. Thus, a higher H_{ci}, does not necessary means a lower δ₁₈₀. Moreover, the control sample Nd_{11 9}Fe_{77 2}Co_{5.5}B_{5.4} exhibits a Bᵣ and H_{ci} of 9.10 kG and 9.74 kOe, respectively, and a T_{c} of 360° C. and a δ₁₈₀ of −11.2%. Thus, the combination of high Bᵣ and H_{ci} does not lead to any improvements of δ₁₈₀.

Turning to the present invention, both Nd_{11.5}Fe_{81.2}Nb_{1.4}B_{5.9} and Nd_{11.5}Fe_{81 4}Nb_{1 2}B_{5 9} exhibit Bᵣ and H_{ci} values of about 8.5 kG and 12.4 kOe, respectively, and δ₁₈₀ of −5.0 and −5.7%. These low ε₁₈₀ values are important to, and desired by, advanced applications. They are achieved by the composition adjustment and microstructure control described herein; and are less likely to be achieved, if they could be achieved at all, by the conventional alloy composition and microstructure control. More importantly, magnets of this invention exhibit the least β when compared to that of controls. This is unexpected from knowledge taught by the prior art.

### Example 2

Alloy ingots having compositions expressed in stoichiometric formula of R₂Fe₁₄B and R₂(Fe_{0.95}Co_{0.5})₁₄B, where R is Nd and/or Pr; and ingots having compositions, in atomic percentage of Nd_{11.5}Fe_{81.2}Nb_{1.4}B_{5.9} and Nd_{11.5}Fe_{81.4}Nb_{1.2}B_{5.9} were prepared by arc melting. A laboratory jet caster with a metallic wheel of good thermal conductivity was used for melt spinning. A wheel speed of 10 to 30 m/s was used for preparing samples. Melt-spun ribbons were crushed to less than 40 mesh and annealed at temperature in the range of 600 to 700° C. for four minutes to develop the highest Bᵣ and H_{ci}. This powder was then mixed with a 2 wt % of epoxy and 0.02 wt % of zinc stearate and dry-blended for 30 minutes. The mixed compound was then compression-molded in air with a compression pressure of 4 T/cm² for form magnets with diameters of 9.2 mm and with a permeance coefficient of 2 (PC=2). Table II lists the nominal alloy compositions and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀).

TABLE II

| | Br | H_{ci} | (BH)ₘₐₓ | T_{c} | α % | β % | δ₁₈₀ | |
|---|---|---|---|---|---|---|---|---|
| Formula Expression | kG | kOe | MGOe | ° C. | ° C. | ° C. | % | Remarks |
| Nd₂Fe₁₄B | 8.90 | 9.6 | 16.0 | 312 | −0.166 | −0.336 | −8.93 | Control |
| (Nd_{0.75}Pr_{0.25})₂Fe₁₄B | 8.70 | 9.8 | 15.5 | | −0.175 | −0.364 | −10.41 | Control |
| Pr₂Fe₁₄B | 8.52 | 10.9 | 15.3 | 308 | −0.183 | −0.416 | −12.66 | Control |
| Nd₂(Fe_{0.95}Co_{0.05})₁₄B | 9.00 | 8.9 | 16.3 | 288 | −0.140 | −0.345 | −11.75 | Control |
| (Nd_{0.75}Pr_{0.25})₂(Fe_{0.95}Co_{0.05})₁₄B | 8.92 | 9.2 | 16.3 | 356 | −0.141 | −0.361 | −10.75 | Control |
| Pr₂(Fe_{0.95}Co_{0.05})₁₄B | 8.64 | 10.4 | 15.5 | 337 | −0.154 | −0.398 | −14.56 | Control |
| Nd_{11.5}Fe_{81.2}Nb_{1.4}B_{5.9} | 8.53 | 12.4 | 15.2 | 300 | −0.187 | −0.318 | −5.01 | This invention |
| Nd_{11.5}Fe_{81.4}Nb_{1.2}B_{5.9} | 8.56 | 12.4 | 15.5 | 300 | −0.182 | −0.318 | −5.76 | This invention |

As can be seen, the control sample of stoichiometric R₂Fe₁₄B exhibits Bᵣ and H_{ci} values of up to 8.9 kG, and 10.9 kOe, respectively. These values are comparable to that of this invention's compositions of Nd_{11.5}Fe_{81.2}Nb_{1.4}B_{5.9} and Nd_{11.5}Fe_{81.4}Nb_{1.2}B_{5.9}. However, the δ₁₈₀ value of the stoichiometric R₂Fe₁₄B is much higher than that of the magnets of this invention. A 5% Co substitution for Fe increases the T_{c} and lowers the α of R₂(Fe_{0.95}Co_{0.5})₁₄B when compared to that of R₂Fe₁₄B (where R=Nd or Pr). However, the δ₁₈₀ of even these cobalt-substituted controls are still much higher that of the magnets of this invention.

### Example 3

Alloy ingots having compositions, in atomic percentage, of Nd_{12.1}Fe₇₉._{7-w1}CO_{w1}Nb_{1.7}B_{6.5}, where w1=5.5, 11.0 and 16.5, and Nd_{11.5}Fe_{81.2-w2}Co_{w2}Nb_{1.4}B_{5.9}, where w2=2.7, 3.8 and 5.4, were prepared by arc melting. A laboratory jet caster with a metallic wheel of good thermal conductivity was used for melt spinning. A wheel speed of 10 to 30 m/sec was used for preparing samples. Melt-spun ribbons were crushed to less than 40 mesh and annealed at temperature in the range of 600 to 700° C. for four minutes to develop the highest Bᵣ and H_{ci}. This powder was then mixed with a 2 wt % of epoxy and 0.02 wt % of zinc stearate and dry-blended for 30 minutes. The mixed compound was then compression-molded in air with a compression pressure of 4 T/cm² to form magnets with diameters of 9.2 mm and with a permeance coefficient of 2 (PC=2). Table Ell lists the nominal alloy compositions and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀).

TABLE III

| | | | | | | | | |
|---|---|---|---|---|---|---|---|---|
| Co Content | Br | H_{ci} | (BH)ₘₐₓ | T_{c} | α % | β % | δ₁₈₀ | |
| w1 or w2 | kG | kOe | MGOe | ° C. | ° C. | ° C. | % | Remarks |

Nd_{12·1}Fe_{79-7-w1}Co_{W1}Nb_{1.7}B_{6.5}

| | | | | | | | | |
|---|---|---|---|---|---|---|---|---|
| 0.0 | 8.19 | 12.8 | 14.0 | 305 | −0.183 | −0.350 | −6.08 | This invention |
| 5.5 | 8.25 | 12.5 | 14.3 | 364 | −0.141 | −0.364 | −9.94 | Control |
| 11.0 | 8.45 | 11.9 | 15.0 | 421 | −0.102 | −0.381 | −14.02 | Control |
| 16.5 | 8.37 | 11.8 | 14.7 | 477 | −0.064 | −0.395 | −18.05 | Control |

Nd_{11·5}Fe_{81.2-w1}Co_{w2}Nb_{1.4}B_{5.9}

| | | | | | | | | |
|---|---|---|---|---|---|---|---|---|
| 0 | 8.53 | 12.4 | 15.2 | 300 | −0.187 | −0.318 | −5.01 | This invention |
| 2.7 | 8.60 | 12.2 | 15.5 | 331 | −0.157 | −0.323 | −6.70 | Control |
| 3.8 | 8.62 | 11.7 | 15.4 | 342 | −0.151 | −0.326 | −7.81 | Control |
| 5.4 | 8.73 | 11.9 | 15.9 | 360 | −0.143 | −0.331 | −9.11 | Control |

As can be seen, Co-substitution for Fe increases the Bᵣ values slightly at appropriate Co concentrations. More importantly, Co-substitution for Fe increases the T_{c} and reduces the α of both alloy systems. Despite the increase the increase in T_{c} and improvement in α, the δ₁₈₀ worsens consistently with increasing Co content. Although the Co-free materials have the lowest δ₁₈₀, the Nd, Nb and B contents need to be carefully adjusted and balanced to obtain a Bᵣ of 8.53 kG as demonstrated the present invention's composition of Nd_{11.5}Fe_{81.2}Nb_{1.4}B_{5.9}.

### Example 4

Alloy ingots having compositions, in atomic percentage, of Nd_{11.5-y}Fe_{81.2}Nb_{1.4}Zr_{y}B_{5.9}, where y=0, 1, 2, 3, were prepared by arc melting. A laboratory jet caster with a metallic wheel of good thermal conductivity was used for melt spinning. A wheel speed of 10 to 30 in/sec was used for preparing samples. Melt-spun ribbons were crushed to less than 40 mesh and annealed at temperature in the range of 600 to 700° C. for four minutes to develop the highest Bᵣ and H_{ci}. This powder was then mixed with a 2 wt % of epoxy and 0.02 wt % of zinc stearate and dry-blended for 30 minutes. The mixed compound was then compression-molded in air with a compression pressure of 4 T/cm² to form magnets with diameters of 9.2 mm and with a permeance coefficient of 2 (PC=2). Table IV lists the nominal alloy compositions and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀).

TABLE IV

| | | | | | | | | |
|---|---|---|---|---|---|---|---|---|
| Zr Content | Br | H_{ci} | (BH)ₘₐₓ | T_{c} | α % | β % | δ₁₈₀ | |
| y | kG | kOe | MGOe | ° C. | ° C. | ° C. | % | Remarks |

Nd_{11·5-y}Fe_{81.2}Nb_{1.4}Zr_{y}B_{5.9}

| | | | | | | | | |
|---|---|---|---|---|---|---|---|---|
| 0 | 8.44 | 12.8 | 14.8 | 300 | −0.187 | −0.318 | −5.01 | This invention |
| 1 | 8.50 | 12.4 | 15.1 | 294 | −0.207 | −0.328 | −5.39 | Control |
| 2 | 8.63 | 12.0 | 15.5 | 286 | −0.231 | −0.349 | −8.13 | Control |
| 3 | 8.34 | 9.7 | 13.0 | 278 | −0.258 | −0.370 | −10.82 | Control |

As can bee seen, a dilute amount of Zr addition at y=1 and 2 slightly increases the Bᵣ values. However, this increase in Bᵣ is at the cost of increased δ₁₈₀. The δ₁₈₀ increase drastically as y increases from 1 to 3. Thus, as discovered in the present invention, not every refractory element is necessarilly suitable for reducing the δ₁₈₀. A careful selection of the refractory metal and the amount is important. This knowledge is not obvious, and has not been taught by the prior art.

### Example 5

Alloy ingots having compositions, in atomic percentage, of NdₓFe_{91.8-x}Nb_{1 7}B_{6.5}, where x=11.5, 11.8, 12.0 and 12.1, were prepared by arc melting. A laboratory jet caster with a metallic wheel of good thermal conductivity was used for melt spinning. A wheel speed of 10 to 30 m/sec was used for preparing samples. Melt-spun ribbons were crushed to less than 40 mesh and annealed at temperature in the range of 600 to 700° C. for four minutes to develop the highest Bᵣ and H_{ci}. This powder was then mixed with a 2 wt % of epoxy and 0.02 wt % of zinc stearate and dry-blended for 30 minutes. The mixed compound was then compression-molded in air with a compression pressure of 4 T/cm² to form magnets with diameters of 9.2 mm and with a permeance coefficient of 2 (PC=2). Table V lists the nominal alloy compositions, all of which are embodiments of the present invention, and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀).

TABLE V

| | | | | | | | |
|---|---|---|---|---|---|---|---|
| Nd Content | Br | H_{ci} | (BH)ₘₐₓ | T_{c} | α %/ | β %/ | δ₁₈₀ |
| x | kG | kOe | MGOe | ° C. | ° C. | ° C. | % |

NdₓFe_{91.8-}ₓNb_{1.7}B_{6.5}

| | | | | | | | |
|---|---|---|---|---|---|---|---|
| 12.1 | 8.19 | 12.8 | 14.0 | 305 | −0.183 | −0.350 | −6.08 |
| 12.0 | 8.26 | 12.7 | 14.4 | 305 | −0.182 | −0.349 | −6.05 |
| 11.8 | 8.30 | 12.2 | 14.3 | 305 | −0.181 | −0.347 | −5.98 |
| 11.5 | 8.36 | 12.3 | 14.6 | 305 | −0.180 | −0.345 | −5.97 |

As can be seen, varying Nd content in this range has limited impacts on the T_{c}, α, β and δ₁₈₀ values. However, reducing the Nd content from 12.1 to 11.5 at % increases the Bᵣ from 8.19 to 8.36 kG and the (BH)ₘₐₓ from 14.0 to 14.6 MGOe. Furthermore, a slight decrease in H_{ci} results. To achieve a Bᵣ of more than 8.3 kG, one needs to design the alloy with appropriate Nd content. This is not obvious, and has not been taught by the prior art.

### Example 6

Alloy ingots having compositions, in atomic percentage, of NdₓFe_{92.7-x}Nb_{1.4}B_{5.9}, where x=11.4, 11.5, 11.8 and 12.0, were prepared by arc melting. A laboratory jet caster with a metallic wheel of good thermal conductivity was used for melt spinning. A wheel speed of 10 to 30 m/sec was used for preparing samples. Melt-spun ribbons were crushed to less than 40 mesh and annealed at temperature in the range of 600 to 700° C. for four minutes to develop the highest Bᵣ and H_{ci}. This powder was then mixed with a 2 wt % of epoxy and 0.02 wt % of zinc stearate and dry-blended for 30 minutes. The mixed compound was then compression-molded in air with a compression pressure of 4 T/cm² to form magnets with diameters of 9.2 mm and with a permeance coefficient of 2 (PC=2). Table VI lists the nominal alloy compositions, all of which are embodiments of the present invention, and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀).

TABLE VI

| | | | | | | | |
|---|---|---|---|---|---|---|---|
| Nd Content | Br | H_{ci} | (BH)ₘₐₓ | T_{c} | α %/ | β %/ | δ₁₈₀ |
| x | kG | kOe | MGOe | ° C. | ° C. | ° C. | % |

NdₓFe_{92.7-}ₓNb_{1.4}B_{5.9}

| | | | | | | | |
|---|---|---|---|---|---|---|---|
| 12.0 | 8.44 | 12.8 | 14.8 | 300 | −0.187 | −0.332 | −5.82 |
| 11.8 | 8.56 | 12.6 | 15.4 | 300 | −0.181 | −0.322 | −5.61 |
| 11.5 | 8.61 | 12.4 | 15.6 | 300 | −0.187 | −0.318 | −5.01 |
| 11.4 | 8.59 | 12.5 | 15.6 | 303 | −0.184 | −0.320 | −5.31 |

The alloy compositions of this alloy series are nearly identical to those listed in Example 5, with the exception of boron content. As can bee seen, by reducing the boron content from 6.5 at %, as used in Example 5, to 5.9 at %, significant increases in Bᵣ can be obtained. The Br values of NdₓFe_{92.7-x}Nb_{1.4}B_{5.9} range from 8.44 to 8.61 kG, while those listed in Example 5 range from 8.19 to 8.36 kG. Furthermore, all magnets of this example all exhibit a δ₁₈₀ value of less than −6%. This suggests that the boron content is also critical to the Bᵣ values which can be obtained. Again, this is not obvious, and has not been taught in the prior art.

### Example 7

Alloy ingots having compositions, in atomic percentage, of Nd_{12 0}Fe_{82.1-y}Nb_{y}B_{5.9} and Nd_{11 5}Fe_{82 6-y}Nb_{y}B_{5.9}, where y=1.0, 1.2 or 1.4, were prepared by arc melting. A laboratory jet caster with a metallic wheel of good thermal conductivity was used for melt spinning. A wheel speed of 10 to 30 m/sec was used for preparing samples. Melt-spun ribbons were crushed to less than 40 mesh and annealed at temperature in the range of 600 to 700° C. for four minutes to develop the highest Bᵣ and H_{ci}. This powder was then mixed with a 2 wt % of epoxy and 0.02 wt % of zinc stearate and dry-blended for 30 minutes. The mixed compound was then compression-molded in air with a compression pressure of 4 T/cm² to form magnets with diameters of 9.2 mm and with a permeance coefficient of 2 (PC=2). Table VII lists the nominal alloy compositions, all of which are embodiments of the present invention, and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀).

TABLE VII

| | | | | | | | |
|---|---|---|---|---|---|---|---|
| Nb Content | Br | H_{Ci} | (BH)ₘₐₓ | T_{c} | α | β | δ₁₈₀ |
| y | kG | kOe | MGOe | ° C. | %/° C. | %/° C. | % |

Nd_{12.0}Fe_{82.1-}_{y}Nb_{y}B_{5.9}

| | | | | | | | |
|---|---|---|---|---|---|---|---|
| 1.4 | 8.44 | 12.8 | 14.8 | 300 | −0.187 | −0.332 | −5.82 |
| 1.0 | 8.60 | 12.1 | 12.1 | 298 | −0.185 | −0.336 | −6.69 |

Nd_{11.5}Fe_{82.6-y}Nb_{y}B_{5.9}

| | | | | | | | |
|---|---|---|---|---|---|---|---|
| 1.2 | 8.56 | 12.4 | 15.5 | 300 | −0.182 | −0.318 | −5.76 |
| 1.4 | 8.61 | 12.4 | 15.6 | 300 | −0.187 | −0.318 | −5.01 |

In this example, both the Nd and B content are adjusted to near the optimum levels to achieve the highest Bᵣ and lowest δ₁₈₀. As can be seen, for a fixed Nd and B content, the δ₁₈₀ varies with the Nb content. For Nd_{12.0}Fe_{82.1-y}Nb_{y}B_{5.9}, increasing the Nb content leads to a slight decrease in Bᵣ but a significant reduction in δ₁₈₀. For Nd_{11 5}Fe_{82.6-y}Nb_{y}B_{5.9}, increasing the Nb content leads to a slight increase in Bᵣ and a reduction in δ₁₈₀, similar to that of Nd_{12.0}Fe_{82.1-y}Nb_{y}B_{5.9}. These results further demonstrate this invention's discovery that one needs to carefully balance the Nd, Nb and boron contents to near stoichiometric to maximize the Bᵣ and minimize the δ₁₈₀ of the magnetic materials obtained.

### Example 8

Alloy ingots having compositions, in atomic percentage, of NdₓFe_{94 1-x-y}Nb_{y}B_{5.9} where x=11 and 12 and y=1.0, 1.4 and 1.7, were prepared by arc melting. A laboratory jet caster with a metallic wheel of good thermal conductivity was used for melt spinning. A wheel speed of 10 to 30 m/sec was used for preparing samples. Melt-spun ribbons were crushed to less than 40 mesh and annealed at temperature in the range of 600 to 700° C. for four minutes to develop the highest Bᵣ and H_{ci}. This powder was then mixed with a 2 wt % of epoxy and 0.02 wt % of zinc stearate and dry-blended for 30 minutes. The mixed compound was then compression-molded in air with a compression pressure of 4 T/cm² for form magnets with diameters of 9.2 mm and with a permeance coefficient of 2 (PC=2). Table VIII lists the nominal alloy compositions, all of which are embodiments of the present invention, and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀).

TABLE VIII

| | | | | | | | | |
|---|---|---|---|---|---|---|---|---|
| Nb | Nb | | | | | | | |
| Con- | Con- | | | | | | | |
| tent | tent | Br | H_{ci} | (BH)ₘₐₓ | T_{c} | α %/ | β %/ | δ₁₈₀ |
| x | y | kG | kOe | MGOe | ° C. | ° C. | ° C. | % |

NdₓFe_{94.1-x-y}Nb_{y}B_{5.9}

| | | | | | | | | |
|---|---|---|---|---|---|---|---|---|
| 12 | 1.4 | 8.44 | 12.8 | 14.8 | 300 | −0.187 | −0.332 | −5.82 |
| 12 | 1.0 | 8.60 | 12.1 | 12.1 | 298 | −0.185 | −0.336 | −6.69 |
| 11 | 1.7 | 8.48 | 12.1 | 14.9 | 305 | −0.192 | −0.325 | −6.41 |

As shown in Table VIII, this example illustrates that Bᵣ, H_{ci}, T_{c}, and δ₁₈₀ can be adjusted by balancing the Nd and Nb contents in appropriate combinations.

### Example 9

Alloy ingots having compositions, in atomic percentage, of dₓFc_{98.3-x-z}Nb_{1.7}B_{z}, where x=11.4, 11.5, 12.0 and z=5.9 and 6.5, were prepared by arc melting. A laboratory jet caster with a metallic wheel of good thermal conductivity was used for melt spinning. A wheel speed of 10 to 30 m/sec was used for preparing samples. Melt-spun ribbons were crushed to less than 40 mesh and annealed at temperature in the range of 600 to 700° C. for four minutes to develop the highest Bᵣ and H_{ci}. This powder was then mixed with a 2 wt % of epoxy and 0.02 wt % of zinc stearate and dry-blended for 30 minutes. The mixed compound was then compression-molded in air with a compression pressure of 4 T/cm² to form magnets with diameters of 9.2 mm and with a permeance coefficient of 2 (PC=2). Table IX lists the nominal alloy compositions, all of which are embodiments of the present invention, and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀).

TABLE IX

| | | | | | | | | |
|---|---|---|---|---|---|---|---|---|
| Nd | B | | | | | | | |
| Con- | Con- | | | | | | | |
| tent | tent | Br | H_{ci} | (BH)ₘₐₓ | T_{c} | α %/ | β %/ | δ₁₈₀ |
| x | z | kG | kOe | MGOe | ° C. | ° C. | ° C. | % |

NdₓFe_{98.3-x-z}Nb_{1.7}B_{z}

| | | | | | | | | |
|---|---|---|---|---|---|---|---|---|
| 12.0 | 6.5 | 8.26 | 12.7 | 14.4 | 305 | −0.187 | −0.349 | −6.05 |
| 12.0 | 5.9 | 8.44 | 12.8 | 14.8 | 300 | −0.185 | −0.332 | −5.82 |
| 11.5 | 6.5 | 8.36 | 12.3 | 14.6 | 305 | −0.180 | 0.345 | −5.97 |
| 11.4 | 5.9 | 8.59 | 12.5 | 15.6 | 303 | −0.184 | −0.320 | −5.31 |

This example illustrates that Bᵣ, H_{ci} T_{c}, and δ₁₈₀ can be adjusted by balancing the Nd and B contents in appropriate combinations.

### Example 10

Alloy ingots having compositions, in atomic percentage, of Nd_{11.5}Fe_{82.6}B_{5.9} and Nd_{11.5}Fe_{81.2}Nb_{1.4}B_{5.9} were prepared by arc melting. A laboratory jet caster with a metallic wheel of good thermal conductivity was used for melt spinning. A wheel speed of 10 to 30 m/sec was used for preparing samples. Melt-spun ribbons were crushed to less than 40 mesh and annealed at temperature in the range of 600 to 700° C. for four minutes to develop the highest Bᵣ and H_{ci}. This powder was then mixed with a 2 wt % of epoxy and 0.02 wt % of zinc stearate and dry-blended for 30 minutes. The mixed compound was then compression-molded in air with a compression pressure of 4 T/cm² to form magnets with diameters of 9.2 mm and with a permeance coefficient of 2 (PC=2). Table X lists the nominal alloy compositions, all of which are embodiments of the present invention, and their corresponding Bᵣ, H_{ci} and (BH)ₘₐₓ values, measured at 20° C., T_{c} values, α and β values, measured at a temperature range of from 22° C. to 108° C., and the flux-aging losses, after exposure at 180° C. for 100 hours in air (denoted as δ₁₈₀). The microstructure of the resultant alloys were examined by Transmission electron Microscopy (TEM) analysis.

TABLE X

| | Br | H_{cl} | (BH)ₘₐₓ | T_{c} | α | β | δ₁₈₀ | |
|---|---|---|---|---|---|---|---|---|
| Formula Expression | kG | kOe | MGOe | ° C. | %/° C. | %/° C. | % | Remarks |
| Nd_{11.5}Fe_{82.6}B_{5.9} | 8.74 | 8.6 | 15.0 | 313 | −0.171 | −0.361 | −13.70 | Control |
| Nd_{11.5}Fe_{81.2}Nb_{1.4}B_{5.9} | 8.53 | 12.4 | 15.2 | 300 | −0.187 | −0.318 | −5.01 | This invention |
| Nd_{11.5}Fe_{79.8}Nb_{2.8}B_{5.9} | 8.07 | 13.2 | 13.7 | 287 | −0.206 | −0.360 | −6.77 | This invention |

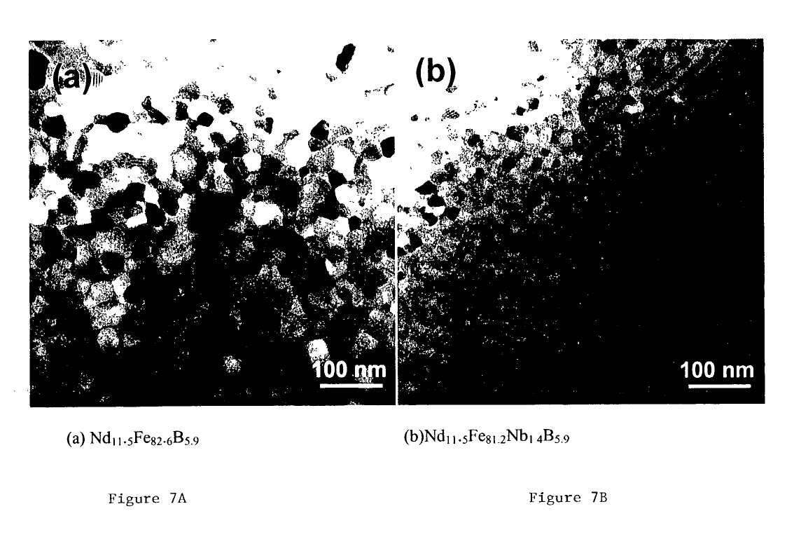

As shown in Table X, Nd_{11.5}Fe_{82.6}B_{5.9} (the control) exhibits a Bᵣ of 8.74 and H_{ci} of 8.6 kOe. The Bᵣ value of the control composition Nd_{11.5}Fe_{82.6}B_{5.9} is higher than that of Nd_{11.5}Fe_{81.2}Nb_{1.4}B_{5.9} (a composition embodying this invention), while the H_{ci} of the control is lower than that of the invention. The δ₁₈₀ of the control is also significantly worse than that of the invention. As shown in FIGS. 7A & 7B, TEM micrographs of the two samples reveal that the average grain size of the control Nd_{11.5}Fe_{82.6}B_{5.9} (FIG. 7A) is larger and more coarse than that of Nd_{11.5}Fe_{81.2}Nb_{1.4}B_{5.9} (this invention, FIG. 7B). Based on these results, Nb not only enters the unit cell of Nd₂Fe₁₄B-based material, but also changes the solidification characteristics and, consequently, the microstructure of the resulting materials. Without being bound by any specific scientific theory, it is believed that the combination of (i) the change in the unit cell characteristics, (ii) fine grain size and (iii) uniform microstructure may lead to the desirably low δ₁₈₀ observed on Nd_{11.5}Fe_{81.2}Nb_{1.4}B_{5.9}.

The present invention has been explained generally, and also by reference to the preceding examples which describe in detail the preparation of the magnetic powders and the bonded magnets of the present invention. The examples also demonstrate the superior and unexpected properties of the magnets and magnetic powders of the present invention. The preceding examples are illustrative only and in no way limit the scope of the present invention. It will be apparent to those skilled in the art that many modifications, both to products and methods, may be practiced without departing from the purpose and scope of this invention.

What is claimed is:

1. A magnetic material having been prepared by a rapid solidification process, followed by a thermal annealing process at a temperature range of about 350° C. to about 700° C. for about 2 to about 120 minutes, said magnetic material having the composition, in atomic percentage, of
REₓFe_{100-x-y-z}M_{y}B_{z}
wherein RE is one or more of Y, La, Ce, Pr, Nd, Sm, Er, Gd, Tb, Dy, Ho, Tm, Yb and Lu; M is one or more of Nb, Ti, Cr, Mo, W, and Hf; x is from about 11.0 to about 12.5; y is from about 0.5 to about 3; and z is from about 4.5 to about 7.0; and
wherein the magnetic material exhibits a remanence (Bᵣ) value of greater than about 8.0 kG and an intrinsic coercivity (H_{ci}) value of greater than about 10.0 kOe.

2. The magnetic material of claim 1, wherein the rapid solidification process is a melt-spinning or jet-casting process.

3. The magnetic material of claim 1, wherein RE is Nd.

4. The magnetic material of claim 1, wherein M is Nb, Ti, or Cr.

5. The magnetic material of claim 4, wherein M is Nb or Ti.

6. The magnetic material of claim 5, wherein M is Nb.

7. The magnetic material of claim 1, wherein x, y and z are independent from each and are from about 11.1 to about 12.0, from about 1.0 to about 2.0 and from about 5.0 to about 6.0, respectively.

8. The magnetic material of claim 7, wherein x is from about 11.2 to about 11.9, y is from about 1.2 to about 1.8 and z is from about 5.3 to about 6.5.

9. The magnetic material of claim 8, wherein x is from about 11.4 to about 11.7, y is from about 1.3 to about 1.7 and z is from about 5.7 to about 6.0.

10. The magnetic material of claim 1, wherein the thermal annealing process is at a temperature range of about 600° C. to about 700° C. for about 2 to about 10 minutes.

11. The magnetic material of claim 1, wherein the material exhibits a Bᵣ value of greater than about 8.3 kG and an H_{ci} value of greater than about 12.0 kOe.

12. The magnetic material of claim 1, wherein the material exhibits a near stoichiometric Nd₂Fe₁₄B single-phase microstructure, as determined by X-Ray diffraction.

13. The magnetic material of claim 1, wherein the material has crystal grain sizes ranging from about 1 nm to about 50 nm.

14. The magnetic material of claim 13, wherein the material has crystal grain sizes ranging from about 5 nm to about 20 nm.

15. A bonded magnet comprising a bonding agent and a magnetic material, said magnetic material having been prepared by a rapid solidification process, followed by a thermal annealing process at a temperature range of about 350° C. to about 700° C. for about 2 to about 120 minutes, and having the composition, in atomic percentage, of
REₓFe_{100-x-y-z}M_{y}B_{z}
wherein RE is one or more of Y, La, Ce, Pr, Nd, Sm, Er, Gd, Tb, Dy, Ho, Tm, Yb and Lu; M is one or more of Nb, Ti, Cr, Mo, W, and Hf; x is from about 11.0 to about 12.5, y is from about 0.5 to about 3, and z is from about 4.5 to about 7.0; and
wherein the magnetic material exhibits a remanence (Bᵣ) value of greater than about 8.0 kG and an intrinsic coercivity (H_{ci}) value of greater than about 10.0 kOe.

16. The bonded magnet of claim 15, wherein the bonding agent is epoxy, polyamide, polyphenylene sulfide, a liquid crystalline polymer, or combinations thereof.

17. The bonded magnet of claim 16, wherein the bonding agent is epoxy.

18. The bonded magnet of claim 15, wherein the bonding agent further comprises one or more additives selected from a high molecular weight multi-functional fatty acid ester, stearic acid, hydroxy stearic acid, a high molecular weight comples ester, a long chain ester of pentaerythritol, palmitic acid, a polyethylene based lubricant concentrate, an ester of montanic acid, a partly saponified ester of montanic acid, a polyolefin wax, a fatty bis-amide, a fatty acid secondary amide, a polyoctanomer with high trans content, a maleic anhydride, a glycidyl-functional acrylic hardener, zinc stearate, and a polymeric plasticizer.

19. The bonded magnet of claim 18, wherein the additive is zinc stearate.

20. The bonded magnet of claim 15, wherein the magnet comprises, by weight, from about 1% to about 5% epoxy and from about 0.01% to about 0.05% zinc stearate.

21. The bonded magnet of claim 20, wherein the magnet comprises, by weight, about 2% epoxy and about 0.02% zinc stearate.

22. The bonded magnet of claim 15, wherein the magnet is made by compression molding, injection molding, calendering, extrusion, screen printing, or combinations thereof.

23. The bonded magnet of claim 22, wherein the magnet has a permeance coefficient of from about 0.2 to about 12.0.

24. The bonded magnet of claim 15, wherein the magnet exhibit a flux-aging loss of less than about 7.0% when aged at 180° C. for 100 hours.

25. The bonded magnet of claim 24, wherein the magnet exhibit a flux-aging loss of less than about 6.0%.

26. The bonded magnet of claim 25, wherein the magnet exhibit a flux-aging loss of less than about 5.5%.

27. A method of making a magnetic material comprising
forming a melt comprising the composition, in atomic percentage, of
REₓFe_{100-x-y-z}M_{y}B_{z};
rapidly solidifying the melt to obtain a magnetic powder;
thermally annealing the magnetic powder at a temperature range of about 350° C. to about 700° C. for about 2 to about 120 minutes;
wherein RE is one or more of Y, La, Ce, Pr, Nd, Sm, Er, Gd, Tb, Dy, Ho, Tm, Yb and Lu; M is one or more of Nb, Ti, Cr, Mo, W, and Hf; x is from about 11.0 to about 12.5; y is from about 0.5 to about 3; and z is from about 4.5 to about 7.0; and
wherein the magnetic material exhibits a remanence (Bᵣ) value of greater than about 8.0 kG and an intrinsic coercivity (H_{ci}) value of greater than about 10.0 kOe.

28. A method of making a bonded magnet comprising
forming a melt comprising the composition, in atomic percentage, of
REₓFe_{100-x-y-z}M_{y}B_{z};
rapidly solidifying the melt to obtain a magnetic powder;
thermally annealing the powder at a temperature range of about 350° C. to about 700° C. for about 2 to about 120 minutes;
mixing and/or coating the magnetic powder with a binding agent; and
pressing and/or molding the powders and binding agent;
wherein RE is one or more of Y, La, Ce, Pr, Nd, Sm, Er, Gd, Tb, Dy, Ho, Tm, Yb and Lu; M is one or more of Nb, Ti, Cr, Mo, W, and Hf; x is from about 11.0 to about 12.5; y is from about 0.5 to about 3; and z is from about 4.5 to about 7.0; and
wherein the magnetic material exhibits a remanence (Bᵣ) value of greater than about 8.0 kG and an intrinsic coercivity (H_{ci}) value of greater than about 10.0 kOe.
